(19) United States
(12) Patent Application Publication
(10) Pub. No.: US 2023/0017107 A1
(43) Pub. Date: Jan. 19, 2023

(54) TRANSPARENT SUBSTRATE WITH THIN FILM MULTILAYER COATING

(71) Applicant: SAINT-GOBAIN GLASS FRANCE, COURBEVOIE (FR)

(72) Inventors: Jin Woo HAN, Seoul (KR); Jaeman HWANG, Gunsan-si (KR)

(21) Appl. No.: 17/784,476

(22) PCT Filed: Dec. 11, 2020
(86) PCT No.: PCT/KR2020/018173

§ 371 Date: Jun. 10, 2022

(30) Foreign Application Priority Data
Dec. 12, 2019 (KR) 10-2019-0165794

(51) Int. Cl. C03C 17/36

(52) U.S. Cl. CPC C03C 17/3668; C03C 17/3657; C03C 17/3642; C03C 17/3626; C03C 17/3618; C03C 2217/212; C03C 2217/27; C03C 2217/281

(57) ABSTRACT

A transparent substrate with a thin film multilayer coating, and the thin film multilayer coating includes a lower dielectric layer, a lower metal protective layer, a metal functional layer having an infrared reflecting function, an upper metal protective layer, and an upper dielectric layer, which are sequentially laminated on the transparent substrate, wherein the lower metal protective layer is thicker than the upper metal protective layer, and the thickness of the upper metal protective layer is 0.3 nm to 0.7 nm.

### TECHNICAL FIELD

The present disclosure relates to a transparent substrate with a thin film multilayer coating. Specifically, the present disclosure relates to a transparent substrate with a thin film multilayer coating in which durability and optical characteristics are improved by adjusting a composition of a layer included in a thin film multilayer coating formed on a transparent substrate.

### BACKGROUND ART

In a case of doors or windows applied to heating devices such as ovens and boilers, infrared rays should be blocked so that high temperatures inside the heating device are not transmitted to the outside while visible rays may be transmitted so that the inside may be seen from the outside. In addition, durability that may withstand a heating environment of a high temperature is required during internal heating. Conventionally, glass without a coating is used, or a configuration forming a transparent conductive coating layer such as a fluorine-doped tin oxide coating or an indium tin oxide (ITO) coating was mainly used in addition to the glass to obtain durability and low emissivity. However, in the case of such a coating layer, it is excellent in durability against heat, but since it has high emissivity and low infrared reflectance, it is difficult to determine that heat transfer from the inside is effectively blocked.

As an alternative to this, it is recommended to apply a high temperature low-emission or low-E glass in which a low-emission layer containing a metal with high reflectivity in an infrared region such as silver (Ag) is deposited as a thin film to the oven door or the like. In glass, the emissivity refers to a degree of which the glass reflects infrared energy of a long wavelength (2500-40,000 nm). The lower the emissivity, the better the reflection and the more infrared energy is reflected, and accordingly, the heat transfer decreases and a heat transmittance value decreases, thereby increasing a heat insulation effect. Therefore, when low-E glass is used for the door or window applied to the heating device, it is possible to effectively block the internal heat from being transferred to the outside. However, in the case of the low-E glass to which such a low-emissivity layer is applied, since the durability at a high temperature is weak, when being applied to the high temperature, the coating is easily peeled off due to phenomena such as a dewetting of a metal layer such as silver, and then there is a problem that it is difficult to be actually applied to the heating device.

### DISCLOSURE OF INVENTION

### Technical Problem

The present invention has been made in an effort to provide a transparent substrate with a multi-layered thin film coating in which durability is improved at a high temperature while having excellent transmittance and emissivity characteristics.

However, tasks to be solved by exemplary embodiments of the present invention may not be limited to the above-described task, and may be extended in various ways within a range of technical scopes included in the present invention.

### Solution to Problem

A transparent substrate according to an exemplary embodiment of the present invention as a transparent substrate with a thin film multilayer coating includes: a transparent substrate; and a thin film multilayer coating, wherein the thin film multilayer coating includes a lower dielectric layer, a lower metal protective layer, a metal functional layer having an infrared reflecting function, an upper metal protective layer, and an upper anti-reflection film, which are sequentially laminated on the transparent substrate, wherein the lower metal protective layer is thicker than the upper metal protective layer, and the thickness of the upper metal protective layer is 0.3 nm to 0.7 nm.

An overcoat on one side of the upper dielectric layer, which is in a direction away from the transparent substrate, may be further included, and the overcoat may include titanium dioxide (TiO₂).

The thickness of the lower metal protective layer may be 1.5 nm to 2.0 nm.

The thickness of the upper metal protective layer may be 0.3 nm to 0.5 nm.

The thickness of the metal functional layer may be 7 nm to 12 nm.

Each of the upper metal protective layer and the lower metal protective layer may include at least one of titanium, nickel, chromium, and niobium, or alloys thereof.

Each of the upper metal protective layer and the lower metal protective layer may include an alloy of nickel-chromium.

Each of the upper dielectric layer and the lower dielectric layer may include a silicon nitride.

Each of the upper dielectric layer and the lower dielectric layer may not be doped with zirconium (Zr) or zinc (Zn) in the silicon nitride.

The thickness of the upper dielectric layer may be 35 nm to 50 nm, and the thickness of the lower dielectric layer may be 30 nm to 45 nm.

A transmission rate of visible light (TL) of the transparent substrate may be 75% to 85%.

A reflection rate of visible light of a coated surface of the transparent substrate may be 3% to 10%.

Normal emissivity of the transparent substrate may be 0.05 to 0.12.

A solar heat gain coefficient of the transparent substrate is less than 0.7.

An oven door according to an exemplary embodiment of the present invention may include the above-described transparent substrate.

According to an exemplary embodiment of the present invention, it is possible to obtain the transparent substrate including the multi-layered thin film coating that has excellent transmittance and emissivity characteristics while improving the durability at high temperatures.

### BRIEF DESCRIPTION OF DRAWINGS

FIG. 1 is a view showing a cross-section of a transparent substrate to which a thin film multilayer coating is provided according to an exemplary embodiment of the present invention.

FIG. 2 is a view showing a result of estimating high temperature durability of a transparent substrate to which a thin film multilayer coating is provided according to an exemplary embodiment of the present invention and a comparative example.

### MODE FOR THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

The drawings and description are to be regarded as illustrative in nature and not restrictive. Like reference numerals designate like elements throughout the specification.

Further, since sizes and thicknesses of constituent members shown in the accompanying drawings are arbitrarily given for better understanding and ease of description, the present invention is not limited thereto. In the drawings, the thicknesses of layers, films, panels, regions, etc., are exaggerated for clarity. In the drawings, for better understanding and ease of description, the thicknesses of some layers and areas are exaggerated.

It will be understood that, although the terms first, second, third, etc. may be used herein to describe various elements, components, regions, layers, and/or sections, they are not limited thereto. These terms are only used to distinguish one element, component, region, layer, or section from another element, component, region, layer, or section. Thus, a first element, component, region, layer, or section discussed below could be termed a second element, component, region, layer, or section without departing from the teachings of the present invention.

The technical terms used herein are to simply mention a particular exemplary embodiment and are not meant to limit the present invention. An expression used in the singular encompasses an expression of the plural, unless it has a clearly different meaning in the context. In the specification, it is to be understood that terms such as “including”, “having”, etc., are intended to indicate the existence of specific features, regions, numbers, stages, operations, elements, components, or combinations thereof disclosed in the specification, and are not intended to preclude the possibility that one or more other specific features, regions, numbers, operations, elements, components, or combinations thereof may exist or may be added.

When a part is referred to as being “on” another part, it can be directly on the other part or intervening parts may also be present. In contrast, when an element is referred to as being “directly on” another element, there are no intervening elements therebetween.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the same meanings as contextual meanings in the relevant field of art, and are not to be interpreted to have idealized or excessively formal meanings unless clearly defined in the present application.

The terms “emissivity” and “transmittance” in the present invention are used as commonly known in the art. The term “emissivity” is a measure representing how much light is absorbed and reflected in a predetermined wavelength. In general, the emissivity satisfies the following equation.

(Emissivity)=1−(Reflectance)

In the present specification, the term “transmittance” means visible light transmittance.

Unless otherwise defined, all terms including technical and scientific terms used herein have the same meaning as commonly understood by those skilled in the art to which the present invention pertains. Terms defined in a generally used dictionary are interpreted as having meanings according with related technical documents and currently disclosed contents, and are not to be interpreted as having idealized meanings or very formal meanings unless otherwise defined.

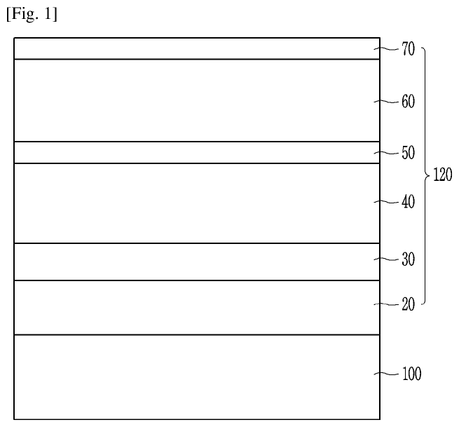

FIG. 1 is a view showing a cross-section of a transparent substrate with a thin film multilayer coating according to an exemplary embodiment of the present invention. The transparent substrate 100 with a thin film multilayer coating of FIG. 1 is only for illustrating the present invention, and the present invention is not limited thereto. Therefore, the transparent substrate 100 with the thin film multilayer coating of FIG. 1 may be transformed into various forms.

Referring to FIG. 1, the transparent substrate 100 with the thin film multilayer coating according to an exemplary embodiment of the present invention includes a transparent substrate 110 and a thin film multilayer coating 120 formed on the transparent substrate 110.

The transparent substrate 110 is not particularly limited, but is preferably made of a hard inorganic material such as glass or an organic material based on a polymer.

The thin film multilayer coating 120 includes a lower dielectric layer 20, a lower metal protective layer 30, a metal functional layer 40 with an infrared reflection function, an upper metal protective layer 50, and an upper dielectric material layer 60 sequentially from the transparent substrate 110. An overcoat 70 is further included on the upper part of the upper dielectric material layer 60, that is, on one side in the direction away from the transparent substrate 110.

The lower dielectric layer 20 and the upper dielectric material layer 60 each includes at least one dielectric material layer. The dielectric layer may include a metal oxide, a metal nitride, or a metal oxynitride. The metal may include at least one of titanium (Ti), hafnium (Hf), zirconium (Zr), zinc (Zn), indium (In), tin (Sn), and silicon (Si).

The lower dielectric layer 20, as shown in FIG. 1, may be formed as a single layer, or may be a laminate of two or more layers, and is not particularly limited. In a preferred example, as shown in FIG. 1, it may be formed in a single layer. The thickness of the lower dielectric layer 20 may be 30 nm to 45 nm. The lower dielectric layer 20 may include silicon nitride (Si₃N₄). The upper dielectric material layer 60, as shown in FIG. 1, may also be formed of the single layer or may include silicon nitride (Si₃N₄). In addition, the upper dielectric material layer 60 may be formed directly on the upper metal protective layer 50 in direct contact with the upper metal protective layer 50. The thickness of the upper dielectric material layer 60 may be 30 nm or more, and more specifically, 35 nm to 50 nm. In addition, the upper dielectric material layer 60 may be thicker than the lower dielectric layer 20, and for example, the thickness ratio of the upper dielectric material layer 60 to the lower dielectric layer 20 may be 1.1:1 to 1.4:1. By adjusting the thickness ratio of the upper dielectric material layer 60 and the lower dielectric layer 20 as described above, the reflection color of the thin film multilayer coating may be adjusted and the transmittance may be simultaneously increased.

The lower dielectric layer 20 and the upper dielectric material layer 60 may be additionally doped with aluminum. By doping aluminum, the dielectric material layer may be formed smoothly in the manufacturing process. In addition to aluminum, various doping agents such as fluorine, carbon, nitrogen, boron, and phosphorus may be used to improve the optical properties of the film as well as the speed of forming the dielectric layer by sputtering. However, it is preferable that the lower dielectric layer 20 and the upper dielectric material layer 60 do not contain zirconium or zinc as a doping element. In the case of these elements, since they are easily bonded with oxygen after heat treatment, moisture resistance and chemical resistance are deteriorated, which is not preferable because it may promote corrosion of the metal functional layer 40.

The metal functional layer 40 has an infrared (IR) reflection characteristic. The metal functional layer 40 may include at least one of gold (Ag), copper (Cu), palladium (Pd), aluminum (Al), and silver (Ag). Specifically, silver or a silver alloy may be included. The silver alloy may include a silver-gold alloy and a silver-palladium alloy. The thickness of the metal functional layer 40 may be 7 nm to 12 nm. If the thickness is too thin, a solar heat gain coefficient (SHGC) may be high. If the thickness is too thick, color coordinates of a transmissive color may move away from blue.

In an exemplary embodiment of the present invention, the lower metal protective layer 30 and the upper metal protective layer 50 formed on each of the lower and upper surfaces of the metal functional layer 40 are included. That is, the lower metal protective layer 30 positioned between the lower dielectric layer 20 and the metal functional layer 40, and the upper metal protective layer 30 positioned between the upper dielectric material layer 60 and the metal functional layer 40, are included. The lower metal protective layer 30 and the upper metal protective layer 50 may prevent oxidation and corrosion of the metal functional layer 70.

For this reason, it is possible to increase the thickness of the lower metal protective layer 30 and the upper metal protective layer 50 to maximize the antioxidant effect, but in this case, it is not desirable because the transmittance of the transparent substrate 100 with the thin film multilayer coating is deteriorated, and the emissivity increases. Therefore, in an exemplary embodiment of the present invention, the sum of the thicknesses of the lower metal protective layer 30 and the upper metal protective layer 50 is 0.6 nm to 2.25 nm. If the sum of the thicknesses of the lower metal protective layer 30 and the upper metal protective layer 50 is less than 0.6 nm, it is difficult to prevent the corrosion of the metal functional layer 70, and if it exceeds 2.25 nm, the transmittance decreases and the emissivity increases, and it is not desirable because the characteristics of the transparent substrate are deteriorated.

In addition, in an exemplary embodiment of the present invention, the thickness of the lower metal protective layer 30 is thicker than that of the upper metal protective layer 50. By making the thickness of the lower metal protective layer 30 thicker than that of the upper metal protective layer 50, the durability, particularly the chemical durability, may be further increased. In the transparent substrate 100 on which the thin film multilayer coating 120 is formed, a stress is applied to the upper dielectric material layer 60 positioned on the upper part, so that the peeling of the thin film multilayer coating 120 is mainly generated in the lower part of the layered structure, that is, the side close to the transparent substrate 110. In an exemplary embodiment of the present invention, by making the thickness of the lower metal protective layer 30 thicker than that of the upper metal protective layer 50, it is possible to more effectively prevent the corrosion and the peeling that may occur on the side close to the transparent substrate 110, therefore, it is possible to obtain more excellent durability compared to the case where the thickness of the lower metal protective layer 30 and that of the upper metal protective layer 50 are the same. As a result, it is possible to achieve the low emissivity performance of the thin film multilayer coating 120, that is, to achieve the low emissivity and the high transmittance, while it is possible to obtain the thin film multilayer coating 120 with the improved durability by simultaneously suppressing the corrosion and the peeling due to this.

In particular, when being used in an environment exposed to high temperatures such as an oven door, the metal such as silver included in the metal functional layer 40 may be melted (wetting) at a high temperature, and when the temperature of the heating device decreases again, the process of the melted metal recrystallizing again is repeated, and during the recrystallization, an impurity may be included and corrosion of the metal may occur, or the metal functional layer 40 may be peeled off. However, according to an exemplary embodiment of the present invention, the metal protective layer having a predetermined thickness range is provided above and below the metal functional layer 40, and particularly at this time, by forming the thickness of the lower metal protective layer 30 to be larger than that of the upper metal protective layer 50, it is possible to suppress the occurrence of such corrosion and peeling.

The thickness of the lower metal protective layer 30 may be 1.5 nm to 2.0 nm, and the thickness of the upper metal protective layer 50 may be 0.3 nm to 0.7 nm. In a preferred embodiment, the thickness of the upper metal protective layer 50 may be 0.3 nm to 0.5 nm.

Each of the lower metal protective layer 30 and the upper metal protective layer 50 may include at least one of titanium, nickel, chromium, and niobium. More specifically, it may include a nickel-chromium alloy.

In addition, an overcoat 70 may be further included on the outermost of the thin film multilayer coating 120. The overcoat 70 is included on the upper metal protective layer 50, that is, on one side away from the transparent substrate 110. The overcoat 70 may include at least one selected from titanium oxide (TiZrO), titanium nitride (TiZrN), titanium oxynitride (TiZrON), zirconium oxide (ZrO), zirconium nitride (ZrN), and zirconium oxynitride (ZrON). Preferably the overcoat 70 may include titanium dioxide (TiO₂). By including the overcoat 70, it is possible to prevent damage of the layers included in the thin film multilayer coating 120. The thickness of the overcoat 70 can be 2 nm to 5 nm.

Due to the above-described configuration, the transparent substrate 100 with the thin film multilayer coating 120 according to an exemplary embodiment of the present invention has excellent characteristics in terms of the emissivity, the transmittance, the durability, the reflectance, and the color.

That is, visible light transmittance TL may be 75% to 85%, and coated surface reflectance may be 3% to 10%. Normal emissivity may be 0.05 to 0.12. A solar heat gain coefficient (SHGC) may be less than 0.7. Here, the solar heat gain coefficient (SHGC (also referred to as “solar heat gain rate”)) represents a ratio of the solar energy inflow through the transparent substrate among the incident solar energy.

The transparent substrate 100 according to an exemplary embodiment of the present invention may be used as a door or window included in a heating device such as an oven or a boiler, and is particularly desirably used because of excellent transmittance and high durability at high temperatures when being included in the oven door.

Hereinafter, the present invention is described in more detail through an experimental example. However, this experimental example is only for illustrating the present invention, and the present invention is not limited thereto.

### Experimental Examples

A transparent substrate with a thin film multilayer coating was formed by stacking a lower dielectric layer/a lower metal protective layer/a metal functional layer/an upper metal protective layer/an upper dielectric material layer on a transparent substrate in that order.

As the transparent substrate, a 5 mm-thickness glass substrate (trade name: Hanlite Clear, manufactured by Korea Glass Industry Co., Ltd.) was used. As the lower dielectric layer, a Si₃N₄ layer was formed at a thickness of 35 nm (however, in Comparative Example 1, 17% zirconium was additionally doped), and as the lower metal protective layer, a NiCr layer was used as shown in Table 1 below and was formed by varying the thickness. A Ag layer was formed at 8.2 nm as the metal functional layer, and a NiCr layer was formed as the upper metal protective layer by varying the thickness as shown in Table 1 below. As the upper dielectric material layer, a Si₃N₄ layer was formed in a thickness of 40 nm, and as an overcoat, a TiO₂ layer was formed at a thickness of 2 nm.

TABLE 1

| | Thickness (nm) | Thickness (nm) | |
|---|---|---|---|
| | of upper metal | of lower metal | Sum (nm) of upper |
| | protective layer | protective layer | and lower metal |
| | (NiCr) | (NiCr) | protective layers |
| Exemplary | 0.3 | 1.5 | 1.8 |
| Embodiment 1 | | | |
| Exemplary | 0.5 | 1.7 | 2.2 |
| Embodiment 2 | | | |
| Exemplary | 0.5 | 2 | 2.5 |
| Embodiment 3 | | | |
| Comparative | 0.3 | 0.8 | 1.1 |
| Example 1* | | | |
| Comparative | 0.3 | 0.8 | 1.1 |
| Example 2 | | | |
| Comparative | 0.3 | 1 | 1.3 |
| Example 3 | | | |
| Comparative | 0.3 | 1.3 | 1.6 |
| Example 4 | | | |
| Comparative | 1 | 1.5 | 2.5 |
| Example 5 | | | |

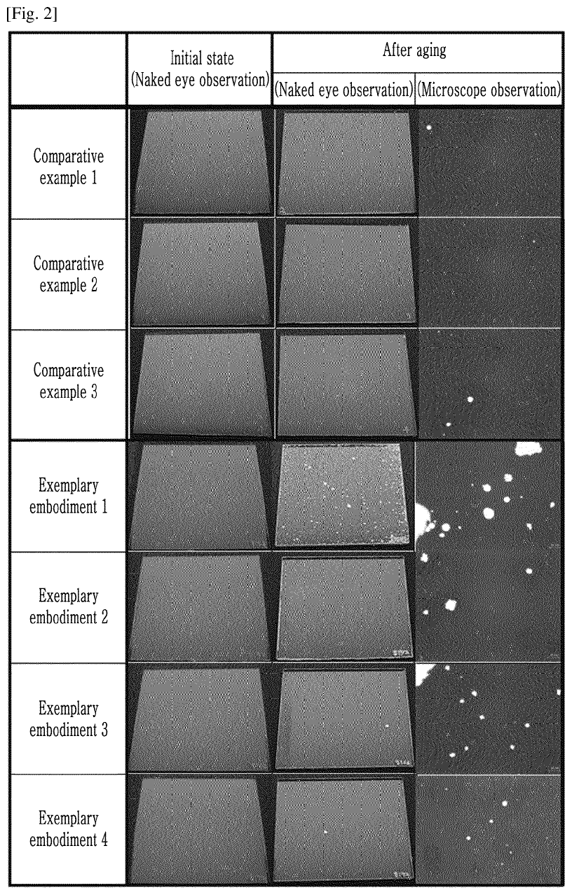

*The lower dielectric layer of the comparative example 1 is a 35 nm Si3N4 layer doped with 17% zirconium. The visible light transmittance and the normal emissivity were measured for the transparent substrate with the thin film multilayer coating of the exemplary embodiment and the comparative example having the stacked structure in Table 1. In addition, in order to test the durability at high temperatures, aging was performed at a temperature of 350° C. for 1000 hours and an observation with the naked eyes and observation with a microscope were performed so that an initial state and a state after the aging could be compared. Upon the microscopic observation, a test area was 480*360 μm. The results thereof are shown in Table 2 and FIG. 2.

TABLE 2

| | Visible light | Normal | High temperature |
|---|---|---|---|
| | transmittance (%) | emissivity | durability** |
| Exemplary | 77 | 0.088 | ◯ |
| Embodiment 1 | | | |
| Exemplary | 75 | 0.09 | ◯ |
| Embodiment 2 | | | |
| Exemplary | 72 | 0.096 | ◯ |
| Embodiment 3 | | | |
| Comparative | 81 | 0.083 | X |
| Example 1* | | | |
| Comparative | 81 | 0.083 | X |
| Example 2 | | | |
| Comparative | 80 | 0.085 | X |
| Example 3 | | | |
| Comparative | 78 | 0.087 | X |
| Example 4 | | | |
| Comparative | 72 | 0.097 | X |
| Example 5 | | | |

A corrosion spot is clearly observed with the naked eye, a case that there are more than 5 spots due to the corrosion and the peeling even under the microscope observation is evaluated as X, and a case that it is less than that is evaluated as O. As shown in the Table 2, it may be confirmed that both visible light transmittance and normal emissivity exhibited excellent characteristics that are commercially available in Exemplary Embodiments 1 to 3 and Comparative Examples 1 to 5 including the metal functional layer. However, as shown in Table 2 and FIG. 2, in Comparative Examples 1-5 in which the thicknesses of the upper metal protective layer and the lower metal protective layer were out of the range of the present invention, spots that may be observed with the naked eyes were generated due to the corrosion and the peeling during the high temperature test, and in the case of the observation by microscope, in the exemplary embodiments, only 2-3 spots of a certain size or larger were observed, whereas in the comparative examples, a plurality of spots were observed, so it is confirmed that the durability at high temperature is deteriorated. Particularly, in Comparative Example 1, a much larger number of spots were observed compared to Comparative Example 2 in which other conditions were the same, so it is determined that this is because the moisture resistance and the chemical resistance are deteriorated by zirconium doped in the lower dielectric layer, which promotes the corrosion.

Meanwhile, a result of comparing the characteristics of the transparent substrate with the thin film multilayer coating of the exemplary embodiment and the transparent substrate including a fluorine doped tin oxide coating used for a conventional oven door is shown below. As the transparent substrate containing the fluorine-doped tin oxide coating, a 4 mm Asahimas Planibel G substrate was used.

TABLE 3

| | | High | Visible light | Solar | |
|---|---|---|---|---|---|
| | Coating layer | temperature | transmittance | heat gain | Normal |
| | configuration | durability | (%) | coefficient | emissivity |
| Comparative | Fluorine-doped | ◯ | 82 | 0.87 | 0.17 |
| Example 6 | tin oxide | | | | |
| Exemplary | Exemplary | ◯ | 77 | 0.6 | 0.09 |
| Embodiment 2 | Embodiment 2 | | | | |
| | Thin film | | | | |
| | multilayer | | | | |
| | coating | | | | |

As shown Table 3, in the case of the transparent substrate with the conventional coating layer, the durability and the transmittance are excellent, but since the solar heat gain coefficient and the normal emissivity are high, when being applied to the door of the heating device, there is a possibility that high temperature heat shielding from the inside cannot be achieved efficiently. On the other hand, in the case of a second exemplary embodiment of the present invention, the transmittance is maintained while securing the high temperature durability, and further, due to the low solar heat acquisition coefficient and the normal emissivity, the heat shielding from the inside is good, thereby showing an excellent heat insulation effect. As described above, according to an exemplary embodiment of the present invention, in the transparent substrate equipped with the thin film multilayer coating, it has also been confirmed that the excellent optical characteristics of the low-E glass such as the visible light transmittance and the normal emissivity are maintained, and at the same time, the durability at a high temperature excellent, therefore it may be suitably used as a door or window (for example, an oven door) of a heating device exposed to a high temperature environment.

The present invention is not limited to the exemplary embodiments and may be produced in various forms, and it will be understood by those skilled in the art to which the present invention pertains that exemplary embodiments of the present invention may be implemented in other specific forms without modifying the technical spirit or essential features of the present invention. Therefore, it should be understood that the aforementioned exemplary embodiments are illustrative in terms of all aspects and are not limited.

### DESCRIPTION OF SYMBOLS

100: transparent substrate with thin film multilayer coating
110: transparent substrate
120: thin film multilayer coating
20: lower dielectric layer
30: lower metal protective layer
40: metal functional layer
50: upper metal protective layer
60: upper dielectric material layer
70: overcoat

1. A transparent substrate with a thin film multilayer coating, comprising:
a transparent substrate; and
a thin film multilayer coating, wherein the thin film multilayer coating comprises a lower dielectric layer, a lower metal protective layer, a metal functional layer having an infrared reflecting function, an upper metal protective layer, and an upper dielectric layer, which are sequentially laminated on the transparent substrate,
wherein the lower metal protective layer is thicker than the upper metal protective layer, and
a thickness of the upper metal protective layer is from 0.3 nm to 0.7 nm.

2. The transparent substrate with the thin film multilayer coating of claim 1,
further comprising an overcoat on one side of the upper dielectric layer, which is in a direction away from the transparent substrate,
wherein the overcoat comprises titanium dioxide (TiO₂).

3. The transparent substrate with the thin film multilayer coating of claim 1,
wherein the thickness of the lower metal protective layer is from 1.5 nm to 2.0 nm.

4. The transparent substrate with the thin film multilayer coating of claim 1,
wherein the thickness of the upper metal protective layer is from 0.3 nm to 0.5 nm.

5. The transparent substrate with the thin film multilayer coating of claim 1,
wherein a thickness of the metal functional layer is from 7 nm to 12 nm.

6. The transparent substrate with the thin film multilayer coating of claim 1,
wherein each of the upper metal protective layer and the lower metal protective layer comprises at least one of titanium, nickel, chromium, and niobium, or alloys thereof.

7. The transparent substrate with the thin film multilayer coating of claim 6,
wherein each of the upper metal protective layer and the lower metal protective layer comprises an alloy of nickel-chromium.

8. The transparent substrate with the thin film multilayer coating of claim 1,
wherein each of the upper dielectric layer and the lower dielectric layer comprises a silicon nitride.

9. The transparent substrate with the thin film multilayer coating of claim 8,
wherein each of the upper dielectric layer and the lower dielectric layer is not doped with zirconium (Zr) or zinc (Zn) in the silicon nitride.

10. The transparent substrate with the thin film multilayer coating of claim 1,
wherein a thickness of the upper dielectric layer is from 35 nm to 50 nm, and a thickness of the lower dielectric layer is from 30 nm to 45 nm.

11. The transparent substrate with the thin film multilayer coating of claim 1,
having a transmission rate of visible light (TL) that is from 75% to 85%.

12. The transparent substrate with the thin film multilayer coating of claim 1,
having a reflection rate of visible light of a coated surface that is from 3% to 10%.

13. The transparent substrate with the thin film multilayer coating of claim 1,
having a normal emissivity that is from 0.05 to 0.12.

14. The transparent substrate with the thin film multilayer coating of claim 1,
wherein having a solar heat gain coefficient that is less than 0.7.

15. An oven door comprising the transparent substrate with the thin film multilayer coating of claim 1.
